(19) United States
(12) Patent Application Publication
(10) Pub. No.: US 2004/0050407 A1
(43) Pub. Date: Mar. 18, 2004

(54) Apparatus for the automatic cleaning of liquid storage tanks

(76) Inventor: Royal Jones, Keystone Heights, FL (US)

Correspondence Address: Kevin Redmond, 6960 SW Gator Trail, Palm City, FL, 34990, US

(21) Appl. No.: 10/618,368

(22) Filed: Jul. 12, 2003

Related U.S. Application Data
(60) Provisional application No. 60/396,963, filed on Jul. 19, 2002.

(51) Int. Cl. B08B 3/00

(52) U.S. Cl. 134/56 R; 134/113; 134/168 R; 134/169 R; 134/198

(57) ABSTRACT

A liquid storage tank cleaning apparatus which utilizes the power of an existing pump in the tank to provide automatic cleaning and removal of both floating debris and sediment. The cleaning action is initiated, carried out and terminated automatically, greatly reducing the cost of monitoring and operating the system.

### BACKGROUND

1. Field

The present invention is related to sewage liquid storage tanks such as lift stations and more particularly to the automatic cleaning of the pits in such stations.

2. Prior Art

A number of prior art inventions have been made to clean liquid storage tanks and sewage waste lines as evidenced by the following summaries of U.S. patents:

U.S. Pat. No. 5,037,486 describes a method for cleaning liquid storage tanks which uses a remotely guided vehicle containing a sludge auger, a sludge pump, crawler tracks and hydraulic motors for propulsion. The vehicle is directed by personnel located above the tank to clean specific areas of the floor of the tank. The vehicle operation requires personnel for control of the vehicle and this system does not remove surface debris.

U.S. Pat. No. 5,988,188 describes an apparatus for removing obstructions from sewers in which a nozzle producing a jet of steam or hot water is directed at the obstruction. The operation is not automatic and an external source of high pressure steam or water is required.

U.S. Pat. No. 5,626,684 describes apparatus for removal of sewage clogs. An external high pressure water pump is connected to a nozzle by way of a hose. The nozzle is directed at a clog to remove it. Personnel are required to direct the operation and external equipment is required.

As can be seen from the prior art apparatus described above, there is a need for an automatic clearing system that does not require personnel to initiate, monitor or direct the operation and ideally the system should not require an external source of water pressure to carry out the cleaning operation. These and other features are provided by the system of the present invention described below.

### BRIEF DESCRIPTION OF THE DRAWINGS

FIG. 1 is a pictorial diagram showing a side sectional view of a lift station pit with the lift station's pump connected to the nozzle and venturi tube of the present invention.

### SUMMARY

It is an object of the present invention to provide a means of cleaning a liquid storage tank and in particular the pit of a sewage lift station without requiring an external source of pressurized water.

It is an object of the present invention to provide a system for cleaning liquid storage tanks which is automatic in that personnel are not required for initiation, control or termination of the cleaning operation.

It is an object of the present invention to provide a system for cleaning liquid storage tanks which remove both floating debris as well as settled sludge.

The present invention provides a means of cleaning a liquid storage tank which utilizes the power of an existing pump in the tank to provide automatic cleaning of the tank and remove floating debris and sediment. The cleaning action is initiated, carried out and terminated automatically, greatly reducing the cost of the monitoring and operating the system.

Many liquid storage tanks and in particular, the pits in sewage lift stations have submersible pumps to remove the fluid from the pit through a discharge line. In the present invention, this line is tapped through a shunt and directed downward towards the bottom of the tank through a nozzle that is housed within a venturi. The downward pressure in the venturi draws down surface debris and mixes it with the liquid in the tank, enabling it to be pumped out of the pit through the discharge line. Similarly, the pressure from the nozzle dislodges sediment on the bottom of the tank, dissolving it in the body of liquid within the tank which enables it to be taken in by the pump and discharged from the pit through the discharge line.

The nozzle is activated and terminated automatically by a ball float which turns on and off a valve located in the shunt line. The operation of this valve depends on the water level in the pit. When the water in the pit is over a first preset limit, the valve is turned on. When the water level falls below a second lower preset level, the valve is shut off, thus causing the cleaning action to be initiated and terminated automatically.

### DETAILED DESCRIPTION OF THE INVENTION

As noted, a lift station includes a tank or a pit and a submersible pump which pump out sewage to higher levels. In the prior art, these pits had to be cleaned with a backhoe to remove deposited sludge and sediment. In some cases, the sludge would build up to the point where it would block the intake of the pump, closing the station down. With the present invention, the constant cleaning and inspecting required previously has been eliminated.

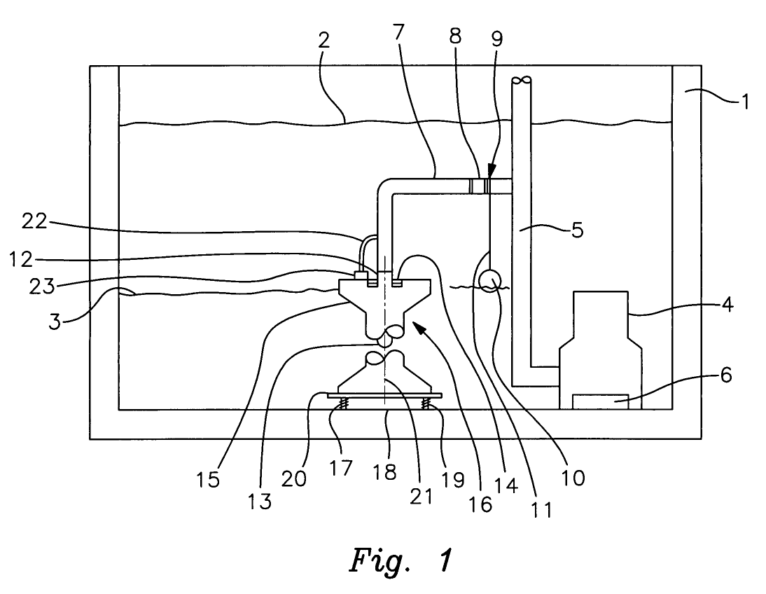

FIG. 1 is a pictorial diagram showing a side sectional view of a lift station pit with the lift station's pump 4 connected to a nozzle 12 and a venturi 16. The walls 1 of the lift station pit enclose water containing sewage. The high water mark of this water is indicated by drawing numeral 2 while the low water mark of this water is indicated by drawing numeral 3. The pump has, near its bottom, an inlet port 6. The pump discharges the water into discharge line 5 which delivers the water to a higher level. Water is tapped off from the discharge line through a shunt line 7 which supplies the water to the nozzle 12 which is housed within the venturi 16.

The water from the nozzle 12 is sprayed out from the end of the nozzle 15 against the floor 18 of the pit. The venturi housing is generally tubular with a wide diameter at the top and the bottom and a narrow diameter in the center. The central area is necked down and referred to as the throat area of the venturi. This shape is used to draw debris from the surface of the water in the pit through the venturi and dissolve it into the body of water in the tank. The nozzle 12 is held inside the venturi by an attachment means 14 located at the top of the venturi. The venturi itself may be adjusted in height above the floor by a means 17. Means 14 and 17 are typically large diameter bolts threaded into the side and bottom respectfully of the venturi.

A center line 21 is drawn vertically through the venturi and the nozzle for references purposes. the nozzle is shown in FIG. 1 with its own center line aligned with that of the venturi. With the nozzle is this position, the stream from the nozzle is focused directly at the floor of the pit. If the nozzle is rotated to have its centerline set at an angle with respect to the centerline of the venturi, then the stream from the nozzle will provide a sidewards thrust to the venturi that will move the venturi about the floor. To permit such movement the shunt 7 is made of flexible material and has sufficient length to extend to every corner of the room. The angle of the nozzle with respect to the centerline of the venturi may be changes in increments or continuously to move the venturi over the entire floor. When the nozzle is set to different angles at different times, the venturi will be moved to different positions on the floor, cleaning a wider area than when the venturi is held in a stationary position. Adding wheels, such as wheel 21 to the base of the venturi will aid in allowing the venturi to move about the floor.

The nozzle may be continuously rotated by rotating its mounting with a motor such as motor 23 which is secured to the top of the venturi and drives a nozzle support arm. The motor may be powered by water pressure derived from shunt 7 through line 22 which connects the shunt to the motor.

In most instances the fixed position venturi is sufficient to clean an average size pit with a floor area of 100 to 300 feet. It is possible to have a fixed position venturi clean an even larger area as well as the walls of a pit with the simple addition of a flange, such as flange 20, which is attached to the outside of the venturi at its bottom and extends outward from the venturi typically from one to three inches in a radial direction from the centerline of the venturi.

The top of the venturi, where fluid is drawn in is referred to as the venturi inlet port, while the bottom of the venturi where the fluid is ejected is referred to as the venturi outlet port. Normally, where no flange is used, the outward flow from the outplet port of the venturi impinges on the floor and then is repelled causing the flow to be upward past the outer sides of the venturi. When the flange is used, the flow cannot flow upward past the outside of the venturi because it is blocked by the flange. Instead it is directed toward the sides of the room where is covers more floor space and cleans the sides walls of the pit.

In the operation of the system shown in FIG. 1, when the water level within the pit is at the high water mark such as at mark 2, a valve 8 in the shunt line is opened by means of a float 10 and a line 11. The line is attached at one end to the float and at the other end to a valve control lever 9. When the water level is high, The float rides on top of the water and pulls the attached line 11 upward. In this situation, the line pulls the valve control lever 9 upward to open the valve, allowing water to pass from the discharge line 5 to the nozzle 12 through the shunt line 7.

The nozzle is directed at the floor 18 of the pit. When the nozzle is turned on, it churns the water at the bottom of the pit, forcing sediment into solution into the water. At the same time, the water passing through the nozzle of the venturi causes water from above the venturi and particularly on the surface to be drawn down through the venturi, bringing debris from the surface into solution into the body of water. This body of water is constantly being drawn off through the pump's inlet port 6. The pump discharges this water out through the discharge line 5. When the water level falls towards the low water mark 3, the float 10 drops, there is no upward pull on line 11, and the valve 8 automatically closes. This action prevents water from flowing through the shunt 7 to the nozzle.

When the water level rises again, the system again allows water to flow through the shunt which continues the cleaning operation. This cycle is repeated every time the water rises and falls, providing an essentially continuous cleaning action on the water's surface and on the floor of the pit.

It should be recognized that many modifications which fall within the spirit and the scope of the invention may be made by those skilled in the art once the above described system has been disclosed. For example, the nozzle need not be supplied by the discharge line, but can be supplied from a separate water pressure source. Various nozzles may be used with narrow openings to provide a narrow high pressure stream to dislodge hard sediment or nozzles with a wider opening and a wider spray area which tend to cover a wider floor area.

Having described my invention, I claim:

1. Apparatus for cleaning liquid holding tanks which include at least sidewalls and a floor and wherein as a minimum both the surface of the liquid and the bottom of the tank are simultaneously cleaned, comprising:
(a) a source of high pressure liquid,
(b) a venturi having a throat, an inlet port and an outlet port, said venturi being placed in said holding tank beneath the liquid in said tank and with said venturi outlet port forming the bottom of said venturi which faces generally downward towards the floor of said tank,
(c) a line for carrying liquid having a first end and a second end, said line being connected at its first end to said source of high pressure liquid, and
(d) a nozzle connected to said second end of said line for carrying liquid to receive the high pressure liquid from said source of high pressure liquid, said nozzle being positioned in said venturi to direct the discharge from said nozzle out of said venturi outlet port.

2. Apparatus as claimed in claim 1, further comprising a pump having an inlet and an outlet port, said pump serving as the source of high pressure liquid and providing said high pressure liquid at its outlet port.

3. Apparatus as claimed in claim 2 wherein said pump accepts as liquid at its inlet port the liquid in said holding tank.

4. Apparatus as claimed in claim 3 wherein said pump is located in said pool.

5. Apparatus as claimed in claim 4 wherein said pump is submersible and positioned in said holding tank beneath the surface level of the liquid in said pool.

6. Apparatus as claimed in claim 1 further comprising means for connecting and disconnecting said nozzle to said line to permit interchanging nozzles adapted to provide different nozzle output sprays from said nozzles to remove different sediments and function in different liquid environments.

7. Apparatus as claimed in claim 1 further comprising a shut off valve in series with said line for carrying liquid and means for opening said valve at a first predetermined high level of the liquid in said tank and shutting off said valve at a predetermined low level in said tank.

8. Apparatus as claimed in claim 7 wherein said means for opening and closing said valve includes a float floating on the surface of the liquid in said tank and a link between said valve and said float to cause said valve to open when said float is at said first level and to close when said float is at said second level.

9. Apparatus as claimed in claim 1 wherein said line is flexible and has a length that will permit said venturi to reach all areas of the floor of said tank and said nozzle is set at an angle with respect to the floor of the tank other than 90 degrees to provide a sideward thrust to the venturi to cause the venture to move about the floor of said tank.

10. Apparatus as claimed in claim 9 wherein said venturi includes wheels attached to its bottom to facilitate its movement about the floor of said tank

11. Apparatus as claimed in claim 10 further comprising a motor connected to said venturi and to said nozzle to set said nozzle to a plurality of angles other than 90 degrees as well as including 90 degrees with respect to the floor of said tank to permit said venturi to move in a plurality of directions and cover a wide area of the floor of said tank.

12. Apparatus as claimed in claim 11 wherein said motor is powered by liquid under pressure.

13. Apparatus as claimed in claim 12 wherein the source of said liquid under pressure is said source of high pressure liquid.
